(19) United States
(12) Patent Application Publication
(10) Pub. No.: US 2009/0214687 A1
(43) Pub. Date: Aug. 27, 2009

(54) Injection Molding Machine

(76) Inventors: Werner Eberlein, Erlangen (DE); Stefan Himmel, Pullach (DE); Thomas Kamps, Holzwickede (DE); Johannes Wortberg, Mülheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/991,980

(22) PCT Filed: Aug. 8, 2006
(86) PCT No.: PCT/EP2006/065148

§ 371 Date: May 11, 2009

(30) Foreign Application Priority Data
Sep. 14, 2005 (EP) 10 2005 043 894.6

(51) Int. Cl. B29C 45/80; B29C 45/72

(52) U.S. Cl. 425/150; 425/548

(57) ABSTRACT

There is described an injection molding machine which is provided in particular for injection-compression moulding, wherein the injection moulding machine has at least the following units: an injection unit, a closing unit and a pre-plastification unit. The injection moulding machine also has a linear drive unit which is provided for driving the closing unit. An additional linear drive unit is provided for driving the injection unit.

### CROSS REFERENCE TO RELATED APPLICATIONS

This application is the US National Stage of International Application No. PCT/EP2006/065148, filed Aug. 8, 2006 and claims the benefit thereof. The International Application claims the benefits of German application No. 10 2005 043 894.6 DE filed Sep. 14, 2005, both of the applications are incorporated by reference herein in their entirety.

### FIELD OF INVENTION

The invention relates to an injection molding machine having an injection unit, a closing unit and a pre-plasticizing unit.

### BACKGROUND OF INVENTION

Both the injection unit and the closing unit have electric drives, the electric drive of the injection unit being used for injecting a melt and the electric drive of the closing unit for closing a mold, the melt being injectable into the mold. After injection, subsequent cooling and opening of the mold, the injection molded article is produced. In an injection molding machine, injection molded articles are produced consecutively, a cycle time specifying how much time is required to produce one injection molded article. The cycle time depends, for example, on the use of particular electric drives. In order to achieve high torques or speeds, gears are used. Depending on the mold, a plurality of injection molded articles can also be produced within one cycle. In this case the mold has a shape enabling several articles to be injection molded simultaneously.

To produce optical data media such as CDs or DVDs, injection molding machines are known which are equipped with hydraulic and/or rotary electric drives, one injection side having one or more reciprocating screw systems. Using known drive technology, cycle times of between 2 and 3 seconds can be achieved.

### SUMMARY OF INVENTION

An object of the present invention is to shorten the cycle time in a simple manner.

This object is achieved by an injection molding machine having the features set forth in an independent claim. Other solutions will emerge from the further developments of the injection molding machine as claimed in the dependent claims.

In an injection molding machine, particularly for injection-compression molding, wherein the injection molding machine comprises at least the following units: an injection unit, a closing unit and a pre-plasticizing unit, linear motors are used to drive moving parts. One linear motor is provided for driving the closing unit. Another linear motor is provided for driving the injection unit. By using linear motors for both the closing unit and the injection unit it is possible to reduce the cycle time, as linear motors can be used as direct drives and these can produce a high acceleration and also high forces.

By means of a pre-plasticizing unit, pre-plasticization by means of an extruder, for example, is possible. The extruder conveys plasticized granulate to a melt storage chamber which can accommodate a variable volume of plasticized granulate. From the melt storage chamber the plasticized granulate, i.e. the melt, can be fed to an injection unit. The melt storage chamber is connected to the injection unit e.g. via a valve. The injection unit is, for example, a piston-type injection unit having a piston which can be moved in a linear manner by means of the linear motor for the injection unit.

In contrast to conventional injection molding machines, pre-plasticization by means of an extruder which conveys the melt, e.g. plasticized granulate, to a melt storage chamber with variable volume can be used. The melt storage chamber can then transfer the melt to a piston-type injection unit. The piston-type injection unit can be implemented without a screw.

In an injection molding machine having a piston-type injection unit, the piston of the injection unit is advantageously movable by means of a linear motor. The linear motor allows rapid, precise movement of the piston with high injection forces being applied.

Through the use of linear motors, the injection molding machine gains in dynamic response, as the linear motors used are high-dynamics electric machines. This enables secondary processing times such as an acceleration time to be reduced. Linear motors also make very precise movements possible, meeting in particular the high precision requirements for manufacturing optical data media.

The use of linear motors for both the closing unit and the injection unit in conjunction with pre-plasticization therefore allows short cycle times, as pre-plasticized material is constantly available as melt. The pre-plasticized material is used to form an injection mass. Both the closing of a mold and the injection process can be executed quickly and precisely using a linear motor in each case. For pre-plasticization, in particular a pre-plasticizing unit is used which comprises, for example, a melt storage chamber and a melter. The melter has at least one heating device and a means of conveying the melted material.

The advantage of using continuous pre-plasticization, e.g. by means of a screw pre-plasticization system, is that the melt required for injection can be plasticized, i.e. melted, in parallel with injection. Another advantage is that the screw pre-plasticization system provides a melt that is prepared in a thermally and mechanically extremely uniform manner. An injection molding machine embodied according to the invention therefore makes it possible to manufacture in particular optical data media with reduced cycle times and high precision.

If the injection molding machine is an injection molding machine for injection-compression molding, the use of linear motors for the closing unit and for the injection unit confers particular advantages. With injection-compression molding, the closing of the mold by the closing unit and the injecting of the melt take place simultaneously in part. This simultaneity is not present in conventional injection molding machines which are not designed for injection-compression molding. The simultaneity or rather overlapping of the closing process with the injection process gives rise to more exacting requirements in terms of precise movement of the closing unit and injection unit. These stringent requirements in respect of precise movement can be met in a particularly simple and advantageous manner by using linear motors as linear drive units, as linear motors can produce high accelerations and forces while at the same time providing precise positioning. Consequently, linear motors are advantageously used both for closing, compressing and for injecting.

Compression-injection molding is used particularly when, for example, low injection pressures for injecting the melt into the mold are required. This is the case, for example, when the injection mass must be produced in such a way that it has little internal stress. This is necessary, for example, for manufacturing products with a large surface area such as window panes, or optical data media such as CDs, CD ROMs, DVDs, etc. Particularly in the case of optical data media, it is disadvantageous if the material possesses a high stress, as the functionality of such an optical data media may be adversely affected. The invention therefore also relates in particular to an injection molding machine which is used for producing optical data media.

In a preferred embodiment of the injection molding machine, the machine comprises, as described above, a pre-plasticizing unit, said pre-plasticizing unit comprising a melt storage chamber. The melt storage chamber influences the quality of the injection molding machine in that it is easy to ensure that a melt for injection molding is constantly available, said melt being provided in a simple manner in a consistently homogeneous state.

In another advantageous embodiment, the injection unit is a piston-type injection unit. The piston-type injection unit can be used particularly advantageously in conjunction with a pre-plasticizing unit, as the injection unit now only has to execute a linear movement and the otherwise customary use of a screw is not necessary.

In another advantageous embodiment of the injection molding machine, both the injection unit and the pre-plasticizing unit have a heating device. By means of these at least two heating devices it is again ensured that uniform conditions for the injection process can be created in a simple manner.

An injection molding machine of the inventive type can also be embodied such that the injection molding machine has a closed-loop control device which is designed to control the linear motor for the closing unit and the linear motor for the injection unit.

If the linear drive unit, which is implemented in particular as a linear motor, can be controlled by means of a single control device for both the closing unit and the injection unit, the delay times arising through the use of a bus between two control units are reduced, each control unit being intended to control the linear drive unit of the closing unit and the linear drive device of the injection unit respectively. The control device is, for example, implemented such that it provides position control, speed control and force control for the two linear drive units. As a result of controlling the forces, torques in particular are also controlled.

In another advantageous embodiment, the control device also comprises a current control loop for the two linear drive units, i.e. the linear drive unit of the closing unit and the linear drive unit for the injection unit. For this purpose the control device is connected to a power converter unit for driving the closing unit and to a power converter unit for driving the injection unit. The respective power converter unit comprises power semiconductor components and an appropriate power converter circuit. By using one control device for at least two linear drive units, short signal delay times and an improvement of the injection masses and a reduction in the cycle time are achieved.

### BRIEF DESCRIPTION OF THE DRAWINGS

Examples of an inventive embodiment of an injection molding machine are shown in the accompanying drawings in which:

FIG. 1 shows an injection molding machine,

FIG. 2 shows a closing unit,

FIG. 3 shows a linear drive unit,

FIG. 4 shows an injection unit,

FIG. 5 shows a first cycle of an injection molding process, and

FIG. 6 shows a second cycle of an injection molding process.

### DETAILED DESCRIPTION OF INVENTION

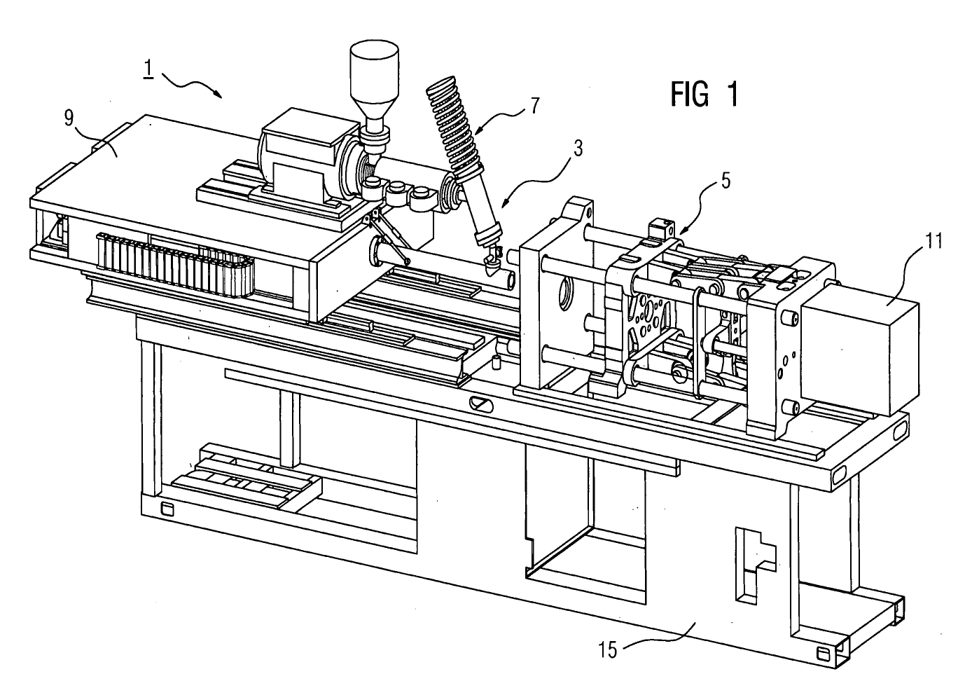

The drawing in FIG. 1 shows an injection molding machine 1. The injection molding machine 1 has a base frame 15. Mounted on the base frame 15 are an injection unit 3 and a closing unit 5. Both the injection unit 3 and the closing unit 5 incorporate linear drive units 9 and 11. The linear drive units 9, 11 have at least one linear motor which, however, is not shown in the drawing in FIG. 1. Also illustrated in FIG. 1 is a pre-plasticizing unit 7.

The combination of employing linear motors for driving:
a) an injection unit 3 which is implemented in particular as a piston-type injection unit and
b) a closing unit 5
   with the use of pre-plasticization and a melt storage chamber 41 for supplying the injection unit is particularly advantageous for manufacturing optical data media by means of an injection-compression process wherein the optical data media are made at least partly of plastic.

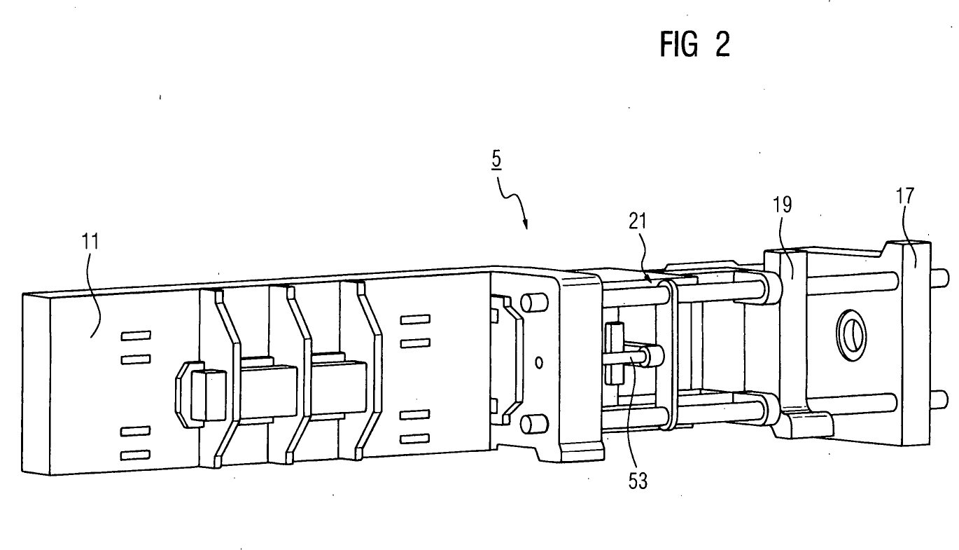

The drawing in FIG. 2 shows a closing unit 5. The closing unit 5 has a linear drive unit 11. The linear drive unit 11 comprises, for example, two linear motors (not shown) which are designed to advance feed rods 53. The feed rods are designed to displace a movable mold plate 19 in a linear manner. The movable mold plate 19 together with a fixed mold plate 17 constitute the mold of the injection molding machine 1.

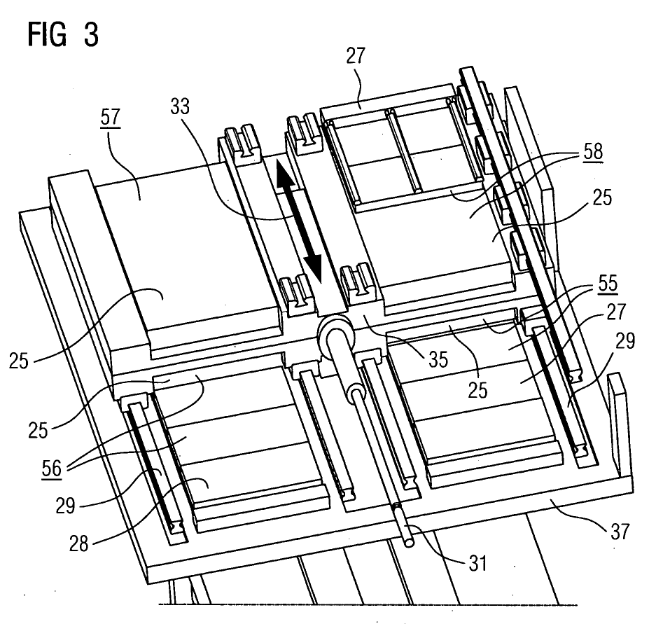

The drawing in FIG. 3 shows a linear drive unit 54 for an injection device. The linear drive unit 54 has four linear motors 55, 56, 57 and 58. The linear motors 55, 56, 57 and 58 each have a primary section and a secondary section, the secondary section of the linear motor 55 being designated by the reference numeral 27 and the secondary section of the linear motor 56 by the reference numeral 28. The secondary section of the linear motor 58 is shown in FIG. 3 with only half a primary section 25 of the linear motor 58. The secondary section of the linear motor 57 is not shown. Each linear motor 55, 56, 57 and 58 has a primary section 25. By means of the linear motors 55, 56, 57 and 58 an injection piston 31 can be moved in a linear direction 33. The linear drive unit 54 can also be equipped with more than four or with less than four linear motors, although this is not shown in FIG. 3. As shown in FIG. 3 the primary section 25 is mounted on a slide 35. The slide 35 to which the injection piston 31 is mounted runs on linear guides 29. The linear guides 29 are connected to a base plate 37. The primary sections 25 can move in the directions 33.

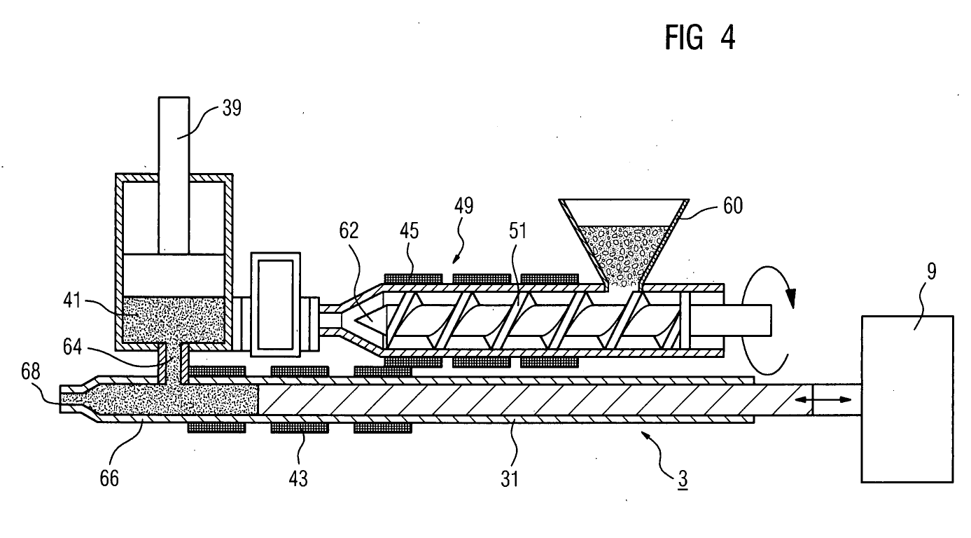

The drawing in FIG. 4 shows an injection unit 3 comprising an injection piston 31. The injection piston 31 can be moved in a linear manner in a piston cylinder 66 by means of a linear drive unit 9. As shown in FIG. 4, injection is separated from plasticization. For plasticization, plastic granulate 62, for example, can be fed to a screw 51 from a hopper 60. By means of the screw 51, the plastic granulate 62 can be conveyed to screw tip 63. While the granulate is being conveyed it can be melted by means of a heating device 45. In the example in FIG. 4, a melter 49 has at least one heating device 45 and one screw 51. The melting plastic granulate is fed by rotation of the screw 51 to a melt storage chamber 41. The conveying of the melting and/or molten plastic granulate also produces homogenization. The screw 51 is continuously operable, as the melt is buffered in the melt storage chamber 41 and can be transferred from the melt storage chamber 41 to the piston cylinder. This is possible because the melt storage chamber 41 can be made larger or smaller via a storage chamber plunger 39. If the melt storage chamber 41 is reduced in size, the melt is forced into the piston cylinder 66 through a storage chamber opening 64. By means of the injection piston 31, the melt can then be forced to a piston cylinder opening. In the region of the piston cylinder 66 a heating device 43 is positioned with which the melt can continue to be heated. The screw 51 advantageously conveys the resulting plastic melt continuously into the melt storage chamber 41 until the injection piston 31 has completed the injection and compression processes. For a new injection process, melt is again forced into the piston cylinder 66 by means of the storage chamber plunger 39.

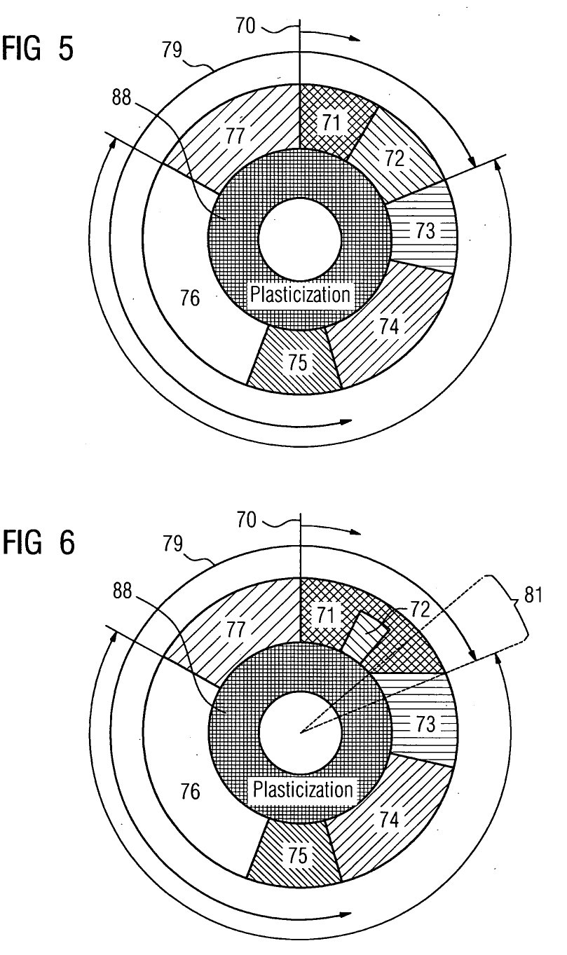

The drawing in FIG. 5 shows a cycle of an injection machine, in particular for an injection-compression process. The start of the cycle 70 takes place with the beginning of the first cycle phase 71. The first cycle phase 71 relates to the closing of a mold. The first cycle phase 71 is followed by a second cycle phase 72. The second cycle phase 72 relates to the advancing of the injection unit, i.e. the advancing of an assembly, said assembly being designed for injecting the melt—particularly a plastic melt. The advancing of the injection device causes the piston cylinder opening to lie against the mold. The second cycle phase 72 is followed by the third cycle phase 73, injection taking place in said cycle phase 73. This is followed by the fourth cycle phase 74 which represents a compression time. In the subsequent fifth cycle phase 75, the assembly, i.e. the injection unit, is retracted from the mold. Retraction of the assembly is followed by a pure cooling time. The pure cooling time corresponds to the sixth cycle phase 76. However, the total cooling time is spread over a plurality of cycle phases. These are the third, fourth, fifth and sixth cycle phase 73, 74, 75 and 76. During the pure cooling time phase 76, however, apart from plasticization 88 no other operation in respect of the primary injection processes takes place. The plasticization phase 88 may therefore extend over the entire cycle because a melt storage chamber is provided as a buffer. The sixth cycle phase 76 is followed by the seventh cycle phase 77. In this cycle phase 77 the mold is opened and the injection molded article is ejected from the mold. It is removed e.g. by means of rams which force the part out of the mold, i.e. the opened tool, it also being possible to employ a removal arm. Throughout the cycle phases 1 to 7 plasticization takes place in the pre-plasticizing unit. The plasticization phase is therefore an eighth cycle phase 88 which in an advantageous embodiment runs continuously over the entire cycle. The cycle time 79 is the time between two injection processes.

The drawing in FIG. 6 shows another advantageous cycle for an injection-compression process which, however, differs somewhat from the cycle shown in FIG. 5. An injection-compression process can, for example, be implemented such that, during closing of the mold, the assembly, i.e. the injection unit, is already advancing to the mold and, during the final phase of closing of the mold, injection is already taking place. This process is graphically illustrated in FIG. 6. Here the cycle phases one, two and 3, 71, 72 and 73 differ in respect of their timing from the phase sequence shown in FIG. 5. The second phase mainly takes place in a time slot parallel to the first phase. When the second phase is complete, the first phase (cycle phase) merges into the third phase in a time overlapping manner. The injection phase 73 can begin even in the cycle time 81, thereby achieving a reduction in the total cycle time.

1-5. (canceled)

6. An injection molding machine, comprising:
an injection unit;
a closing unit;
a pre-plasticizing unit;
a linear drive unit for driving the closing unit; and
a linear drive unit for driving the injection unit.

7. The injection molding machine as claimed in claim 6, wherein the injection molding machine is used for injection-compression molding.

8. The injection molding machine as claimed in claim 6, wherein the pre-plasticizing unit has a melt storage chamber.

9. The injection molding machine as claimed in claim 6, wherein the injection unit is a piston-type injection unit.

10. The injection molding machine as claimed in claim 8, wherein the injection unit is a piston-type injection unit.

11. The injection molding machine as claimed in claim 6, wherein the injection unit has a heating device and the pre-plasticizing unit has a heating device.

12. The injection molding machine as claimed in claim 8, wherein the injection unit has a heating device and the pre-plasticizing unit has a heating device.

13. The injection molding machine as claimed in claim 9, wherein the injection unit has a heating device and the pre-plasticizing unit has a heating device.

14. The injection molding machine as claimed in claim 10, wherein the injection unit has a heating device and the pre-plasticizing unit has a heating device.

15. The injection molding machine as claimed in claim 6, wherein the injection molding machine has a single closed-loop control device to control the linear drive unit for the closing unit and to control the linear drive unit for the injection unit.

16. The injection molding machine as claimed in claim 11, wherein the injection molding machine has a closed-loop control device to control the linear drive unit for the closing unit and to control the linear drive unit for the injection unit.

17. The injection molding machine as claimed in claim 12, wherein the injection molding machine has a closed-loop control device to control the linear drive unit for the closing unit and to control the linear drive unit for the injection unit.

18. The injection molding machine as claimed in claim 13, wherein the injection molding machine has a closed-loop control device to control the linear drive unit for the closing unit and to control the linear drive unit for the injection unit.

19. The injection molding machine as claimed in claim 14, wherein the injection molding machine has a closed-loop control device to control the linear drive unit for the closing unit and to control the linear drive unit for the injection unit.

20. The injection molding machine as claimed in claim 6, wherein the linear drive unit of the closing unit comprises two linear motors mechanically connected to advance feed rods, wherein the feed rods displace a movable mold plate in a linear manner.

21. The injection molding machine as claimed in claim 6, wherein the linear drive unit for the injection device has four linear motors, wherein each linear motor has a primary section and a secondary section, wherein an injection piston is moved in a linear direction by the four linear motors.

22. The injection molding machine as claimed in claim 21, wherein the primary sections are mounted on slides, wherein the slides to which the injection piston is mounted runs on linear guides, wherein the linear guides are mechanically connected to a base plate.
